(19) United States
(12) Patent Application Publication
(10) Pub. No.: US 2009/0300213 A1
(43) Pub. Date: Dec. 3, 2009

(54) METHODOLOGY FOR CONFIGURING AND DEPLOYING MULTIPLE INSTANCES OF A SOFTWARE APPLICATION WITHOUT VIRTUALIZATION

(75) Inventors: Bharat Khuti, Olivette, MO (US); Michael Jushchuk, Chapel Hill, NC (US); Diane Landers, Atlanta, IN (US); Tano Maenza, St. Louis, MO (US); Steve Hassell, Town & Country, MO (US)

Correspondence Address: HARNESS, DICKEY & PIERCE, P.L.C., P.O. BOX 828, BLOOMFIELD HILLS, MI, 48303, US

(73) Assignee: EMERSON ELECTRIC CO., St. Louis, MO (US)

(21) Appl. No.: 12/177,348

(22) Filed: Jul. 22, 2008

Related U.S. Application Data
(60) Provisional application No. 61/057,251, filed on May 30, 2008.

(51) Int. Cl. G06F 15/16

(52) U.S. Cl. 709/238

(57) ABSTRACT

A networked corporate information technology computer system is provided for implementing an enterprise software application. The computer system is comprised of a plurality of server computers networked together in a hub and spoke configuration that defines a hub computer system and at least one spoke computer system, where the hub and spoke computer systems have a shared infrastructure. The shared infrastructure is mediated at each of the hub and spoke computer systems by a profile data structure that identifies a pool of services and further defines a multiple tenant configuration based on port assignments. Each hub and spoke computer system is configured to selectively route data among themselves under control of a workflow system administered by the hub computer system, where the workflow system determines how data is routed to and from that computer system according to a predefined routing optimization scheme.

### CROSS-REFERENCE TO RELATED APPLICATIONS

This application claims the benefit of U.S. Provisional Application No. 61/057,251 filed on May 30, 2008. The disclosure of the above application is incorporated herein by reference.

### FIELD

The present disclosure relates to a methodology for configuring and global deployment of multiple instances of an enterprise software application without virtualization.

### BACKGROUND

A business requirement arose for hosting multiple instances of an enterprise software application for a number of different corporate divisions having either a small number of users and/or limited computing resources. The issue with the enterprise software was that separate set of servers or infrastructure is typically required to host each instance of the software for a particular division. For larger divisions, this is less of an issue as there is usually a large number of users that make this configuration more cost effective, i.e., infrastructure cost is spread across more users and provides better utilization of the hardware. On the other hand, for smaller divisions, using a separate set of infrastructure to host their instance of the software becomes cost prohibitive.

An exercise was undertaken to survey the usage requirements of smaller divisions using various parameters such as number of users, locations of users, etc. Various divisions were grouped into different profiles based on their common attributes. Once this exercise was complete, it became evident that multiple divisions could, in theory, be hosted on a single set of infrastructure. It was further realized that a mix of divisions with different profiles could be supported, i.e., all divisions hosted on a particular infrastructure did not have to have the same profile.

Most software vendors do not support use of their software in a production environment while it is running in a virtual operating system environment. Therefore, it is desirable to provide a methodology for configuring and deploying multiple instances of an enterprise software application for multiple corporate entities having different resource requirements and without virtualization technologies. An additional requirement is provide a common global framework to enable the design and implementation of a common parts catalog or other shared databases.

The statements in this section merely provide background information related to the present disclosure and may not constitute prior art.

### SUMMARY

A networked corporate information technology computer system is provided for implementing an enterprise software application. The computer system is comprised of a plurality of server computers networked together in a hub and spoke configuration that defines a hub computer system and at least one spoke computer system, where the hub and spoke computer systems have a shared infrastructure. The hub system provides a common shared infrastructure, data replication and synchronization and shared databases such as a common parts catalog. The shared infrastructure is mediated at each of the hub and spoke computer systems by a profile data structure that identifies a pool of services and further defines a multiple tenant configuration based on port assignments. Each hub and spoke computer system is configured to selectively route data among themselves under control of a workflow system administered by the hub computer system, where the workflow system determines how data is routed to and from that computer system according to a predefined routing optimization scheme.

Further areas of applicability will become apparent from the description provided herein. It should be understood that the description and specific examples are intended for purposes of illustration only and are not intended to limit the scope of the present disclosure.

### DRAWINGS

FIG. 1 is a diagram illustrating an overview of a networked corporate information technology computer system implementing an enterprise software application;

FIG. 2 is a diagram illustrating how to deploy multiple instances of an enterprise software application on a given hub or spoke computer system;

FIG. 3 is a diagram showing the logical architecture for the proof-of-concept analysis;

FIG. 4 is a diagram of the logical architecture illustrating the assigned installation parameters;

FIG. 5 is a diagram illustrating how to deploy the enterprise software application across a hub and spoke computer system; and

FIG. 6 is a diagram depicting a super hub and spoke configuration.

The drawings described herein are for illustration purposes only and are not intended to limit the scope of the present disclosure in any way.

### DETAILED DESCRIPTION

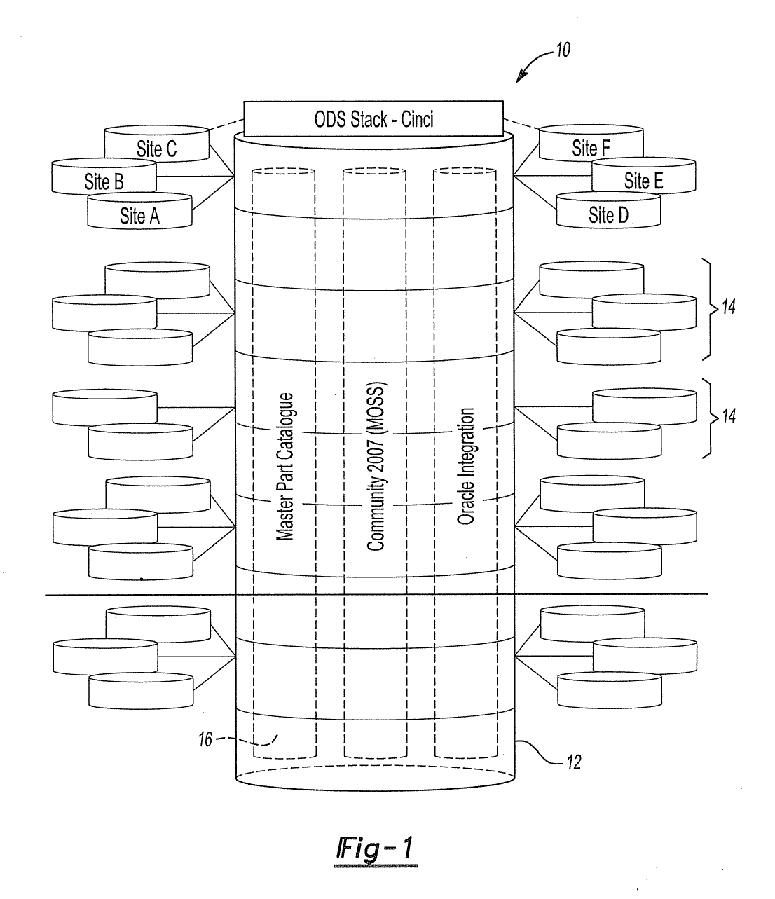

FIG. 1 depicts an overview of a networked corporate information technology computer system 10 implementing an enterprise software application. In an exemplary embodiment, the enterprise software application is a product lifecycle management software application such as the Teamcenter® PLM software commercially available from Siemens. Product lifecycle management software applications from Oracle, SAP and other software providers are also contemplated by this disclosure. Moreover, the broader aspects of this disclosure are applicable to other types of enterprise software applications.

A plurality of server computers are networked together in a hub and spoke configuration that defines a hub computer system indicated at 12 and a plurality of spoke computer systems indicated at 14. The hub and spoke computer system employs a shared infrastructure which may include a corporate intranet and the computing resources which comprise the same. The shared infrastructure is mediated at each of said hub and spoke computer systems by a profile data structure that identifies a pool of services and defines a multiple tenant configuration based on port assignment as will be further described below.

The hub and spoke computer system 10 is also configured with a common data model 16. The common data model may reside on a common data store at the hub computer system and store a common data set that is useable across the entire hub and spoke computer systems. Exemplary data sets may include a universal parts catalog or a universal human resource database. Other types of common data sets are also contemplated by this disclosure.

The hub and spoke computer systems is further configured to selectively route data among themselves under control of a workflow system administered by said hub computer system, where the workflow system determines how data is routed to and from that computer system according to a predefined routing optimization scheme.

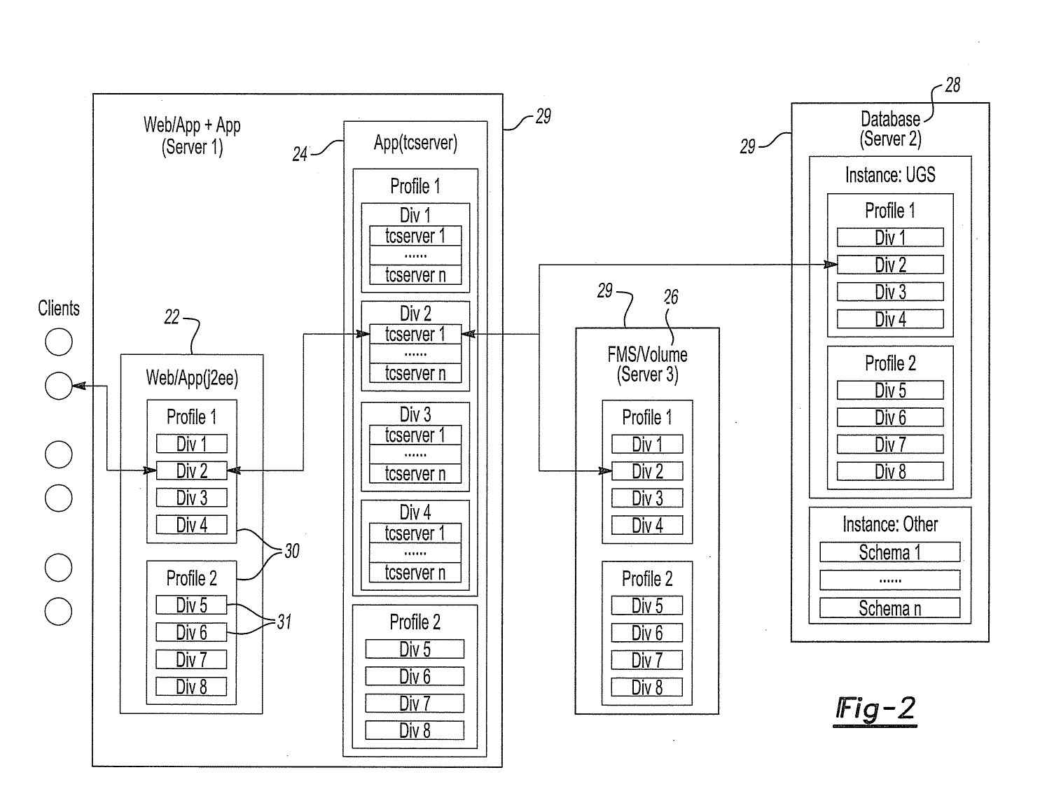

FIG. 2 illustrates how to deploy multiple instances of the enterprise software application on a given hub or spoke computer system. A deployment configuration was chosen with the enterprise software application being separated among multiple application tiers and each application tier residing on a different server computer 29. In this exemplary deployment, the enterprise software application is divided amongst a web application server tier 22, an enterprise tier 24, a file management system tier 26 and a database tier 28. It is envisioned that the web application server tier and the application server tier may be hosted on a single server computer or that each of the tiers may be consolidated onto a single server. However, this preferred configuration was chosen for administrative ease as well as to leverage application installations.

Within each application tier, corporate divisions 31 are supported in different profiles 30 residing on a single server. Divisions 31 having similar computing resource requirements are grouped together in a given profile 30. Thus, a profile 30 can have multiple divisions but a division 31 is associated with only one profile. For example, profile one includes divisions 1-4 and profile two includes divisions 5-8. This is a conceptual representation as the actual number of divisions that can be supported by a profile can vary as determined by a sizing model.

At each hub and spoke computer system, the shared infrastructure is mediated by a profile data structure. In an exemplary embodiment, a directory structure is used to partition resources amongst the profiles and the divisions within each profile. A root directory may be defined for each profile and a common set of binaries (or executable software) is installed into each root directory. In this way, each division within a profile shares a common set of binaries; whereas, divisions in different profiles can share different binaries. In the web application server tier 22, binaries are installed for the web application server software. In the enterprise tier 24, binaries are installed for the enterprise software application. Different profiles may also implement different data models, different workflow processes and/or different replication requirements.

Each root directory may be further partitioned into multiple subdirectories, where each subdirectory is assigned to a different division. Each division within a profile may then have access to certain services and data which is not available to the other divisions in the same profile. To partition resources in the file management system tier 26 and the database tier 28, each division is assigned its own volume and its own database schema, respectively. Other techniques for partitioning resources amongst the different profiles and divisions are also contemplated by this disclosure.

A proof-of-concept analysis was performed to determine the feasibility of having multiple instances of the Teamcenter PLM application set up on a common infrastructure. For this analysis, three Teamcenter instances were set up as follows: Profile 1 having two divisions running Teamcenter 2005SR1 and Profile 2 having one division running Teamcenter 2005SR1MP1. The two profiles with different versions of Teamcenter are used to simulate two different sets of core application binaries. The two divisions within a profile validate the concept of sharing the same application root (and hence the same binaries) for supporting two different corporate entities each with its own database and volume.

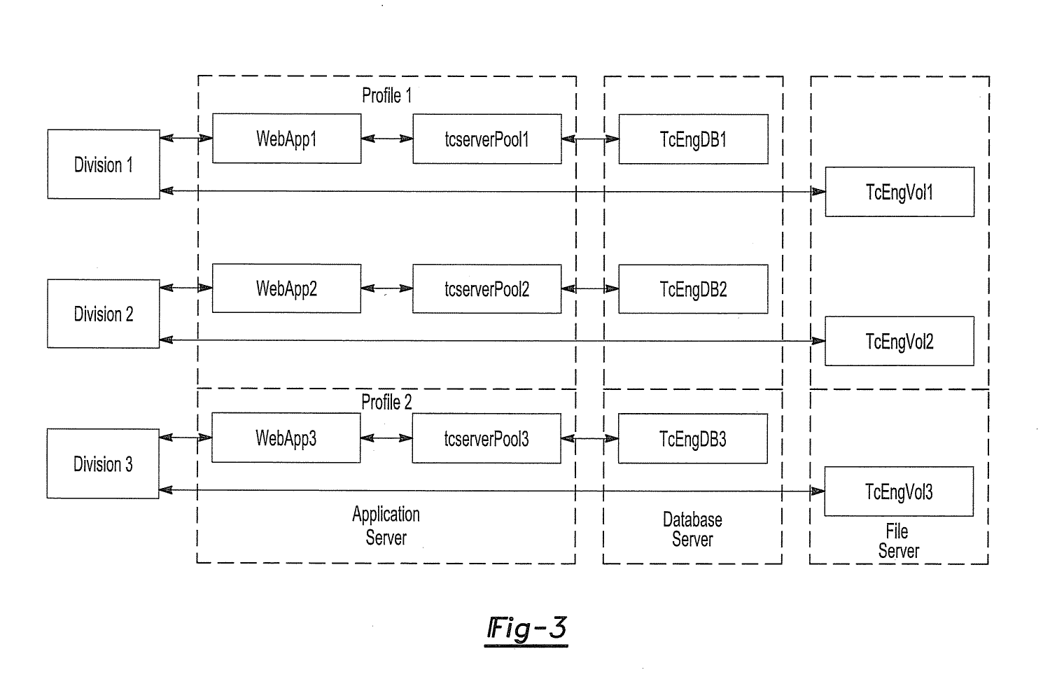

FIG. 3 shows the logical architecture for the proof-of-concept analysis. Users from each division access their own web application that has an associated unique tcserver pool. Each division also has its own database instance and volume. For scalability requirements, this model can be extended by adding additional web applications, tcserver pools or volumes for any of the divisions.

The process of preparing an enterprise application environment begins with determining an application configuration and system architecture. Application configuration includes determining the Teamcenter versions and appropriate patches, as well as determining the types of client (e.g., 2 or 4 tier application client) and any third party applications (e.g., NX, Pro-E, etc.) which are to be integrated into the environment. Determining the system architecture includes defining a deployment configuration, determining hardware requirements and identifying the location for application and data stores.

Once the application configuration and system architecture are determined, the applications are ready to be installed. The installation process is comprised of four primary steps: defining the installation parameters; installing the database; installing the web application server and installing the enterprise application. Each of these steps is further described below.

First, the installation parameters are defined for the different applications. Installation parameters for the proof-of-concept installation are shown in the table below.

| | |
|---|---|
| Profile 1 | Profile 2 |

| | | |
|---|---|---|
| Division 1 | Division 2 | Division 1 |

| | | |
|---|---|---|
| TcEngineering | v2500SR1 | v2005SR1MP1 |
| OS User | eprofile1 | eprofile2 |

| | | | |
|---|---|---|---|
| Database | PRO1DIV1 | PRO1DIV2 | PRO2DIV1 |
| Instance | | | |

Note that one operating system username is required for each profile. It is recommended that operating system usernames be consistent across all of the servers for a given profile.

Second, the database is installed on the database server. In the proof-of-concept installation, an Oracle v10.2.0.2 database with DST patch 5884103 was used. Setting up database instances in preparation for the Teamcenter application installation is done with the objective of having a database instance with a Teamcenter user defined for each division. The “dbca” template script provided with the Teamcenter application was used during the creation of each database instance. Since the default username was used for all database instances and the database files for each database instance were located on separate drives, no changes were necessary for the default template scripts. While it is technically feasible to run multiple database instances using a single instance identifier, it is recommended that each division have its own database instance. It is understood that other types of databases are within the scope of this disclosure.

Third, the web application server is installed. In the proof-of-concept installation, Web logic v8.1.6 with Sun JDK 1.4.2.11 was used as the web application server. Each division in a profile requires one or more Java virtual machines (JVMs). That is, the web application components of multiple divisions should not be installed in the same JVM. For scalability, multiple JVM can be used per division. While reference is made to Weblogic, other types of web application software can be used.

Finally, Teamcenter application can be deployed in various ways to provide optimal performance and scalability. For the proof-of-concept, a centralized approach was chosen since one of the goals is to determine viability of a centralized hosted solution. In this approach, a centralized data center will run multiple instances of the Teamcenter application and clients will access the application across a network.

For setting up a multi-instance Teamcenter environment, it is very important to identify unique values of certain parameters so that there are no conflicts. For each profile, unique parameters need to be assigned for the OS user and the root installation directory. For each division, parameters requiring unique values are shown in the table below:

| | |
|---|---|
| Environment | Teamcenter instance identifier |
| | (Ex: PROFILE1DIVISION1) |
| | Oracle database instance (Ex: PRO1DIV1) |
| | Weblogic server (Ex: tcpro1div1) |
| Teamcenter | TC_DATA directory location - this uniquely identifies |
| | the database associated with a particular division |
| Volumes | Default Volume directory location |
| | Transient Volume directory location |
| File Management | FMS Server Cache (FSC) service name |
| System | FMS Server Cache (FSC) location |
| (FMS) | FSC Port |
| | FMS Client Cache location (for the local 2TierRAC) |
| | TcFS service name and port |
| | 2TierRAC Port |
| Server Manager | Pool Identifier |
| | Cluster Identifier |
| | JMX Port |
| | TCP Port and Port Range |
| | TreeCache host and Port |
| Web application | Distribution server name |
| | Distribution server instance name |
| | RMI Port |

For the installation of the first division in the first profile, unique parameters may be defined as follows:

| Environment | Teamcenter | PROFILE1DIVISION1 |
|---|---|---|
| | instance | |
| | identifier | |
| | OS User | eprofile1 |
| | Oracle | PRO1DIV1 |
| | database | Port: 1521 (same value for multiple |
| | instance | divisions) |
| | Weblogic | tcpro1div1 |
| | server | |
| Teamcenter | TC_ROOT | D:\EmersonSR1 |
| | directory | |
| | TC_DATA | D:\emersontcdata\PRO1DIV1 |
| | directory | |
| Volumes | Volume | P1D1VOL1 |
| | Name | |
| | Default | H:\EmersonVolumes\P1D1VOL1 |
| | Volume | |
| | directory | |
| | location | |
| | Transient | H:\EmersonTransientVolumes\ |
| | Volume | P1D1TransVol |
| | directory | |
| | location | |
| File | FMS Server | FSC_<apperver>-PRO1DIV1 |
| Management | Cache (FSC) | |
| System | service name | |
| (FMS) | FMS Server | H:\EmersonFSCP1D1\FSC1P1D1Cache |
| | Cache (FSC) | |
| | location | |
| | FSC Port | 4444 |
| | FMS Client | $HOME\FCCP1D1Cache |
| | Cache (FCC) | |
| | location | |
| | TcFS service | Tcfs_PRO1D1V1 |
| | name and port | Port: 1531 (can use same for multiple |
| | | divisions) |
| | 2TierRAC Port | 1572 (can use same for multiple divisions) |
| Server | Pool Identifier | P1D1PoolA |
| Manager | Cluster | P1D1ClusterA |
| | Identifier | |
| | JMX Port | 8082 |
| | TCP Port | 17800 |
| | Port Range | 5 (same for all divisions) |
| | TreeCache | <appserver> |
| | host and Port | Port: 17800 |
| Web | Distribution | DistServerPro1Div1 |
| application | server name | |
| | Distribution | DistInstancePro1Div1 |
| | server | |
| | instance name | |
| | RMI Port | 12099 |

Profile 1 may be extended to include a second division. Unique parameters for this second division are also shown below:

| Environment | Teamcenter | PROFILE1DIVISION2 |
|---|---|---|
| | instance | |
| | identifier | |
| | OS User | eprofile1 → NOTE same OS user as |
| | | Division 1 |
| | Oracle | PRO1DIV2 |
| | database | Port: 1521 (same value for multiple |
| | instance | divisions) |
| | Weblogic | tcpro1div2 |
| | server | |
| Teamcenter | TC_ROOT | D:\EmersonSR1 →Note same TC_ROOT |
| | directory | installation |
| | TC_DATA | D:\emersontcdata\PRO1DIV2→Note |
| | directory | different TC_DATA folder |
| Volumes | Volume | P1D2VOL1 |
| | Name | |
| | Default | H:\EmersonVolumes\P1D2VOL1 |
| | Volume | |
| | directory | |
| | location | |
| | Transient | H:\EmersonTransientVolumes\ |
| | Volume | P1D2TransVol |
| | directory | |
| | location | |
| File | FMS Server | FSC_<apperver>-PRO1DIV2 |
| Management | Cache (FSC) | |
| System | service name | |
| (FMS) | FMS Server | H:\EmersonFSCP1D2\FSC1P1D2Cache |
| | Cache (FSC) | |
| | location | |
| | FSC Port | 4445 |
| | FMS Client | $HOME\FCCP1D2Cache |
| | Cache (FCC) | |
| | location | |
| | TcFS service | Tcfs_PRO1D1V2 |
| | name and port | Port: 1531 (can use same for multiple |
| | | divisions) |
| | 2TierRAC Port | 1572 (can use same for multiple divisions) |
| Server | Pool Identifier | P1D2PoolA |
| Manager | Cluster | P1D2ClusterA |
| | Identifier | |
| | JMX Port | 8083 |
| | TCP Port | 17810→ Note number accounting for |
| | | the Port range of 5 for Divisional 1 |
| | Port Range | 5 (same for all divisions) |
| | TreeCache | <appserver> |
| | host and Port | Port: 17810 |
| Web | Distribution | DistServerPro1Div2 |
| application | server name | |
| | Distribution | DistInstancePro1Div2 |
| | server | |
| | instance name | |
| | RMI Port | 12100 |

With the exception of a different OS user for each new profile, the addition of a new profile follows the same process as that used for the first profile. The unique identifiers for the profiles and divisions should be identified and verified before initiating the installation process.

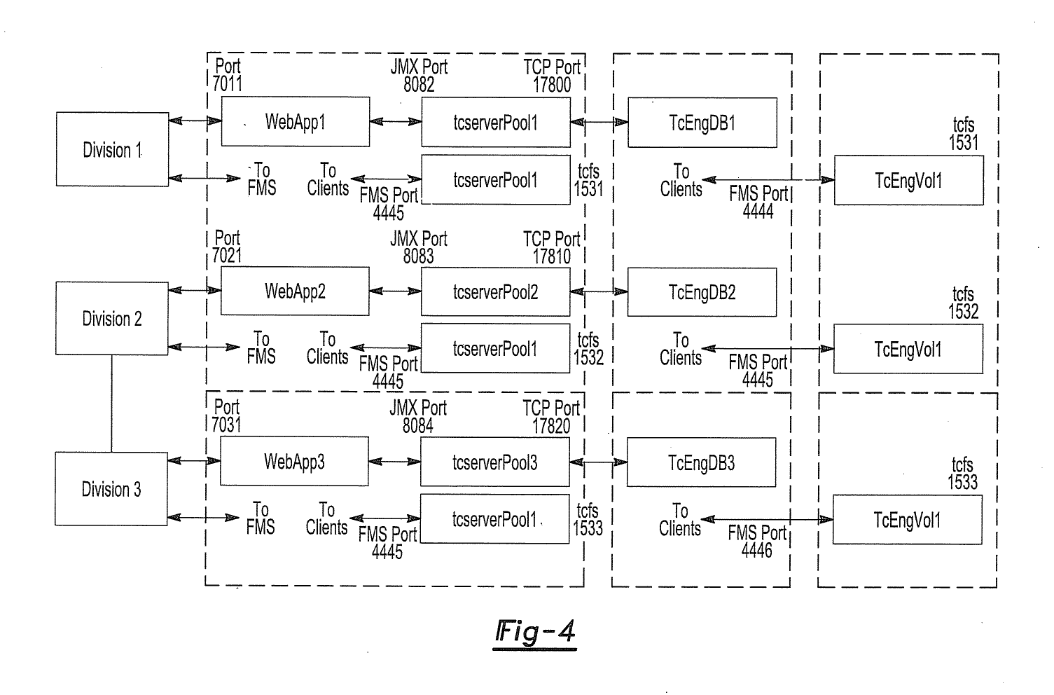

FIG. 4 illustrates the unique parameters as assigned in the proof-of-concept analysis. It is noteworthy that a multiple tenant configuration is achieved primarily through proper configuration of installation parameters. In particular, a naming convention and port assignment schema enable different divisions to access their associated instances of the different components of the enterprise software application. The port assignment schema methodology works by first assigning a unique enterprise-wide range of ports to each division. Then the various components of the enterprise software application are each assigned a specific port, or ports, within that range. The naming conventions, in conjunction with the port schema, also generate the appropriate file system and data source configuration parameters required by the various components during installation and configuration. During runtime, this enables a particular division to access its associated instances of the various components of the enterprise software without interfering with any other divisions that may also be running on the same infrastructure.

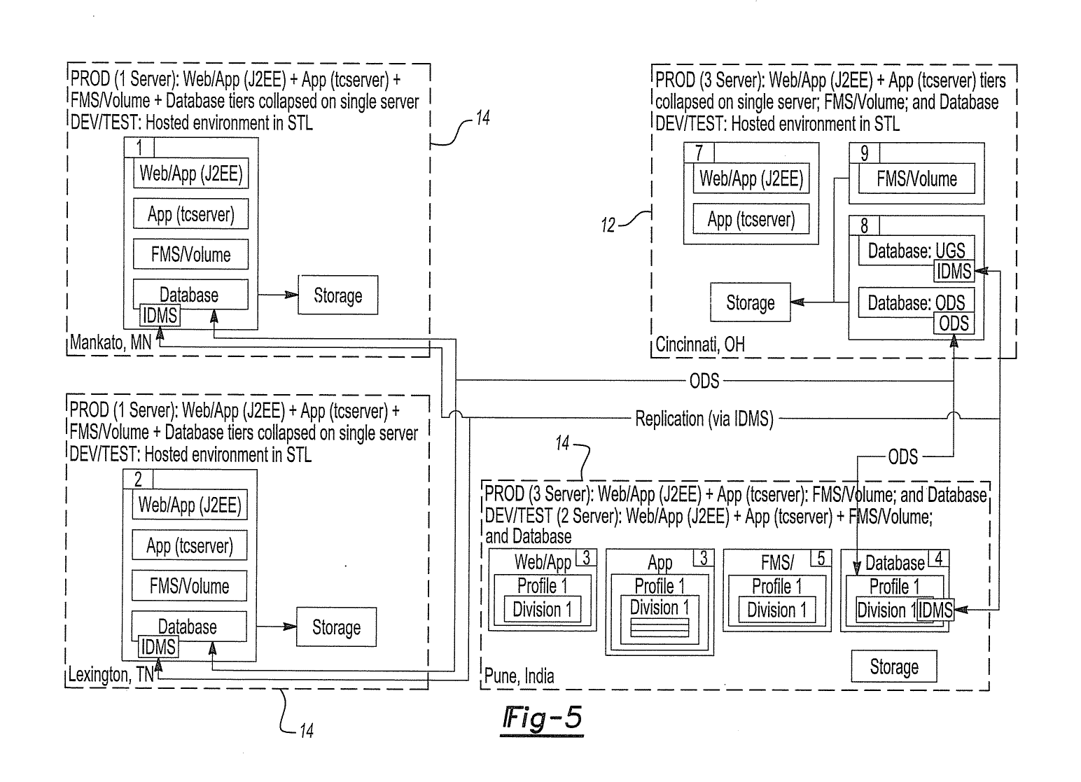

FIG. 5 illustrates how the enterprise software application may be deployed across the hub or spoke computer system. In this exemplary embodiment, the hub computer system 12 resides in Cincinnati while the spoke computer systems 14 reside in Mankato, Lexington and Pune. Multiple instances of the enterprise software application may be deployed at the hub computer system in the manner described above to support different corporate entities. Likewise, multiple instances of the enterprise software application may be deployed at the spoke computer systems. Alternatively, each spoke computer system may be associated with a single corporate entity and thus deploy a single instance of the enterprise software application. Depending on the size of the corporate entity, the enterprise software application may be collapsed onto a single server as shown in Mankato and Lexington.

Within the hub and spoke computer infrastructure, a workflow system is used to route data among the spoke sites. In an exemplary embodiment, the workflow system implements a rule set for document management. For example, the workflow system enables an engineer in Mankato to read but not edit a document created by another engineer in Lexington. The workflow system may also provide a version control mechanism that enables engineers at two different locations to read and edit documents in a collaborative manner. In another example, the workflow system enables transfer of ownership for a document from an engineer whom created the document to an engineer at another location. This portion of the workflow system may be custom developed or supported and implemented by the enterprise software application.

Replication and synchronization of shared data between the sites is also handled by the workflow system. An important aspect of the workflow system is that completed documents be sent to the hub site (e.g., Cincinnati). Within the context of the hub and spoke configuration, this workflow rule enables more efficient use of enterprise resources. From the hub site, the documents may be distributed, if applicable, to spoke sites in a manner which minimizes adverse affects on the enterprise network. For example, data may be replicated to all sites at periodic intervals (e.g., every hour, once per day, etc.). In another example, data may be replicated to geographical proximate sites more frequently (e.g., every hour) than to geographical remotes sites (e.g., every twelve hours for data being sent from Cincinnati to India). Different rules may be defined for different sites, different division as well as different profiles. It is also contemplated that different types of replication and synchronization rules may be formulated. In any case, the rules are preferably defined by a network administrator whom has visibility to the entirety of network traffic.

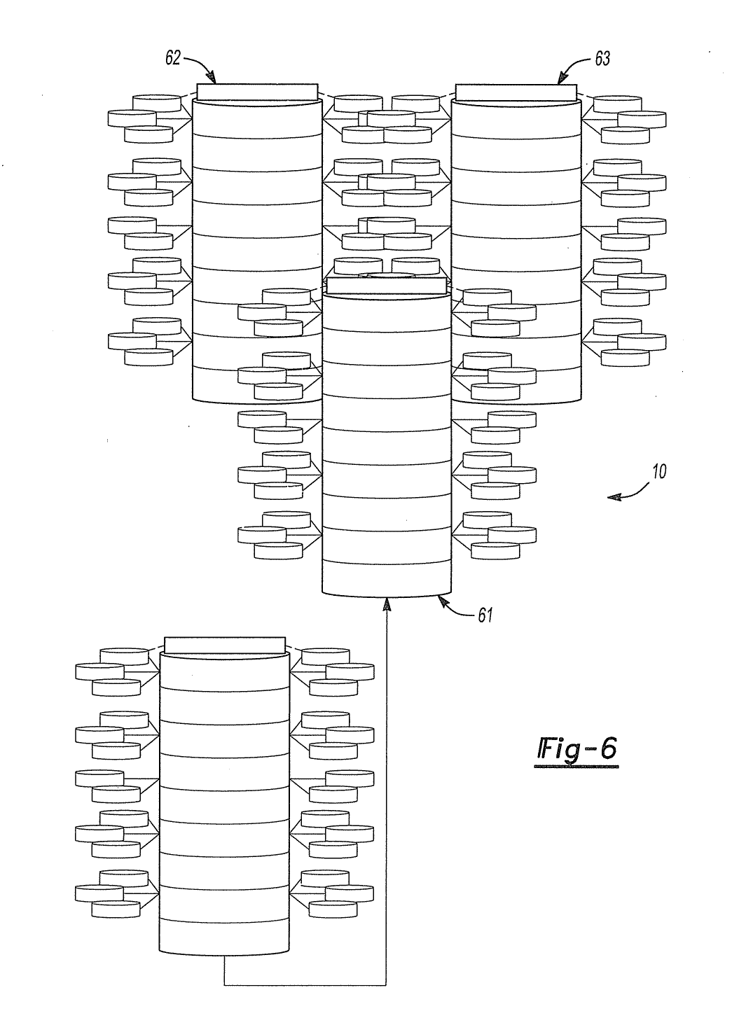

It is also envisioned that the networked corporate information technology computer system 10′ may be comprised of a plurality of clusters of hub and spoke computer systems as shown in FIG. 6. In this arrangement, each of said clusters is joined in a super hub and spoke configuration, where one of the clusters serves as a master hub computer system 61 and the remaining clusters 62, 63 serve as spoke computer systems of the super hub and spoke configuration. Within each cluster is a hub computer system networked together with one or more spoke computer systems. Each computer system in this arrangement may be configured in the manner described above to support an enterprise software application.

The above description is merely exemplary in nature and is not intended to limit the present disclosure, application, or uses.

What is claimed is:

1. A networked corporate information technology computer system implementing an enterprise software application, comprising:
a plurality of server computers networked together in a hub and spoke configuration that defines a hub computer system and at least one spoke computer system;
said hub and spoke computer systems having a shared infrastructure and each being configured using a common data model;
said shared infrastructure being mediated at each of said hub and spoke computer systems by a profile data structure that identifies a pool of services;
said shared infrastructure being further mediated at each of said hub and spoke computer systems by said profile data structure that defines a multiple tenant configuration based on port assignment; and
said hub and spoke computer systems being configured to selectively route data among themselves under control of a workflow system administered by said hub computer system; wherein said workflow system determines how data is routed to and from that computer system according to a predefined routing optimization scheme.

2. The networked system of claim 1 further comprising common data store associated with the common data model of said master hub computer system that stores a common data set useable across all of said hub and spoke computer systems.

3. The networked system of claim 2 wherein said common data store stores a universal parts catalog.

4. The networked system of claim 2 wherein said common data store stores a universal human resources database.

5. The networked system of claim 1 wherein the profile data structure includes a directory structure having subdirectories associated with different corporate entities thereby enabling different corporate entities to access different services in the pool of services.

6. The networked system of claim 1 wherein the profile data structure includes a directory structure having subdirectories associated with different corporate entities such that corporate entities may access different versions of the enterprise software application.

8. The networked system of claim 1 wherein the profile data structure stores port assignments for the enterprise software application accessed by corporate entities where different ports are assigned to different software components for different corporate entities.

9. The networked system of claim 1 wherein the enterprise software application is further defined as a product lifecycle management software application.

10. The networked system of claim 1 wherein the enterprise software application is separated into multiple application tiers and each tier at the hub computer system resides on a different server computer.

11. The networked system of claim 10 wherein the enterprise software application includes a database tier having a separate database instance for each corporate entity.

12. The networked system of claim 10 wherein the enterprise software application includes a file management system tier having a separate segment of the file management system assigned to each corporate entity.

13. The networked system of claim 1 further comprising:
a plurality of clusters of hub and spoke computer systems each of said clusters having a hub computer system;
each of said hub computer systems of said clusters being joined in a super hub and spoke configuration:
wherein the hub computer system of one of said clusters serves as a master hub computer system of said super hub and spoke configuration; and
wherein the hub computer systems of the remaining ones of said clusters serve as spoke computer systems of said super hub and spoke configuration.

14. A networked corporate information technology computer system implementing an enterprise software application, comprising:
a plurality of server computers networked together in a hub and spoke configuration that defines a hub computer system and at least one spoke computer system; said hub and spoke computer systems having a shared infrastructure;
said shared infrastructure being further mediated at each of said hub and spoke computer systems by said profile data structure that defines a multiple tenant configuration based on port assignment, where an instantiation of the enterprise software application is provided for each tenant supported by a given spoke computer system and the profile data structure maps each instantiation of the enterprise software application to a different port; and
said hub and spoke computer systems being configured to selectively route data among themselves under control of a workflow system administered by said hub computer system; wherein said workflow system determines how data is routed to and from that computer system according to a replication and synchronization rule set.

15. The networked system of claim 14 wherein, for the given spoke computer system, each instantiation of the enterprise software application resides on the same server computer.

16. The networked system of claim 11 wherein each tenant supported by the given spoke computer system is assigned to a different database instance.

17. The networked system of claim 14 wherein said master hub computer system provides a common data store that stores a common data set useable across all of said hub and spoke computer systems.

18. The networked system of claim 17 wherein said common data store stores a universal parts catalog.

19. The networked system of claim 14 wherein the profile data structure includes a directory structure having subdirectories associated with different corporate entities thereby enabling different corporate entities to access different services in the pool of services.

20. The networked system of claim 14 wherein the profile data structure includes a directory structure having subdirectories associated with different corporate entities such that corporate entities may access different versions of the enterprise software application.

21. A networked corporate information technology computer system implementing a product lifecycle management software application, comprising:
a plurality of server computers networked together in a hub and spoke configuration that defines a hub computer system and at least one spoke computer system; said hub and spoke computer systems having a shared infrastructure and a common data model in support of multiple corporate entities;
said hub and spoke computer systems provides an instantiation of the product lifecycle management software application for each corporate entity and at least one database instance for each corporate entity;
said shared infrastructure being mediated at each of said hub and spoke computer systems by a profile data structure that allocates a pool of services amongst the corporate entities; and
said hub and spoke computer systems being configured to selectively route data among themselves under control of a workflow system administered by said hub computer system; wherein said workflow system determines how data is routed to and from that computer system according to a predefined routing optimization scheme.

22. The networked system of claim 21 wherein the profile data structure maps each instantiation of the enterprise software application to a different port associated with a hub and spoke computer system.

23. The networked system of claim 21 further comprising common data store associated with the common data model of said master hub computer system that stores a common data set useable across all of said hub and spoke computer systems.

24. The networked system of claim 23 wherein said common data store stores a universal parts catalog.

25. The networked system of claim 21 wherein the profile data structure includes a directory structure having subdirectories associated with different corporate entities thereby enabling different corporate entities to access different services in the pool of services.

26. The networked system of claim 21 wherein the profile data structure includes a directory structure having subdirectories associated with different corporate entities such that corporate entities may access different versions of the enterprise software application.

27. The networked system of claim 21 wherein the enterprise software application is separated into multiple application tiers and each tier at the hub computer system resides on a different server computer.

28. The networked system of claim 27 wherein the enterprise software application includes a database tier having a separate database instance for each corporate entity.

29. The networked system of claim 27 wherein the enterprise software application includes a file management system tier having a separate segment of the file management system assigned to each corporate entity.
